(19) United States
(12) Patent Application Publication
(10) Pub. No.: US 2025/0322022 A1
(43) Pub. Date: Oct. 16, 2025

(54) SEARCHING ON PLATFORMS

(71) Applicant: Airbnb, Inc., San Francisco, CA (US)

(72) Inventors: Clarence Chin-Wei Quah, San Francisco, CA (US); Min Li, San Jose, CA (US); Amisha Patel, St. Louis, MO (US); Aditya Vohra, San Francisco, CA (US); Yan Liu, San Francisco, CA (US); Haowei Zhang, San Francisco, CA (US); Philbert Lin, Glenview, IL (US); Kedar Bellare, Sacramento, CA (US); Adam James Shutsa, San Francisco, CA (US); Xinyi Chen, San Francisco, CA (US)

(21) Appl. No.: 19/175,615

(22) Filed: Apr. 10, 2025

Related U.S. Application Data
(60) Provisional application No. 63/632,203, filed on Apr. 10, 2024.

(51) Int. Cl. G06F 16/9535; G06F 16/9532; G06F 16/9538

(52) U.S. Cl. CPC G06F 16/9535; G06F 16/9532; G06F 16/9538

(57) ABSTRACT

Various aspects of the subject technology relate to systems, methods, and machine-readable media for improving user search experiences on an online searchable platform. Various aspects may include receiving a query input by a user of the platform. Aspects may also include generating, based on executing a search using the query, a search result including one or more listings. Aspects may also include determining at least a modified query based on attributes of the query, the search result, and a user profile. Aspects may also include generating, based on the modified query, a recommendation result including one or more recommended listings. Aspects may include displaying, at the client device, the recommendation result within the search result, wherein a placement of the recommendation result, for example, in a carousel format, is based on a relevance of the recommendation result to the user profile and the search.

### CROSS-REFERENCE TO RELATED APPLICATIONS

The present disclosure is related and claims priority under 35 U.S.C. § 119 (e) to U.S. Provisional Patent Application No. 63/632,203, entitled SEARCH ON PLATFORMS to Clarence Quah, filed on Apr. 10, 2024, the contents of which are hereby incorporated by reference in their entirety, for all purposes.

### TECHNICAL FIELD

The present disclosure is generally related to search features designed to enhance the user search experience on a platform. More specifically, the present disclosure includes the provision of search input suggestions and alternative search options that may be localized and personalized to the user to improve the quality of search results on the platform.

### BACKGROUND

Searching functionality on platforms, such as reservation or booking platforms, is a crucial component of user interactions. A significant number of unique users perform searches, leading to a high volume of total searches. However, users often encounter difficulties in conducting effective searches due to inadequate or complex search tools. This challenge is particularly evident where the uniqueness of each search result option adds to the complexity of the search process. Other searching challenges for users may include difficulty in navigating the search results on the page. Improving search functionalities is essential to facilitate users in discovering optimal search results efficiently.

### BRIEF SUMMARY

The subject disclosure provides for systems and methods for improving the quality of search results in an online platform (for example, an online reservation platform).

According to one embodiment of the present disclosure, a computer-implemented method for search expansion on a platform is provided. The method includes receiving, at a client device, a query input by a user of the platform. The method also includes generating, based on executing a search using the query, a search result including one or more listings. The method also includes determining at least a modified query based on attributes of the query, the search result, and a user profile. The method also includes generating, based on the modified query, a recommendation result including one or more recommended listings. The method also includes displaying, at the client device, the recommendation result within the search result in a search results page user interface (UI), wherein a placement of the recommendation result is based on a relevance of the recommendation result to the user profile and the search.

According to one embodiment of the present disclosure, a system is provided including a processor and a memory comprising instructions stored thereon, which when executed by the processor, causes the processor to receive, at a client device, a query input by a user of the platform, generate, based on executing a search using the query, a search result including one or more listings, determine at least a modified query based on attributes of the query, the search result, and a user profile, generate, based on the modified query, a recommendation result including one or more recommended listings, and display, at the client device, the recommendation result within the search result in a search results page UI, wherein a placement of the recommendation result is based on a relevance of the recommendation result to the user profile and the search.

According to one embodiment of the present disclosure, a non-transitory computer-readable storage medium is provided including instructions (for example, stored sequences of instructions) that, when executed by a processor, cause the processor to receive, at a client device, a query input by a user of the platform, generate, based on executing a search using the query, a search result including one or more listings, determine at least a modified query based on attributes of the query, the search result, and a user profile, generate, based on the modified query, a recommendation result including one or more recommended listings, and display, at the client device, the recommendation result within the search result in a search results page UI, wherein a placement of the recommendation result is based on a relevance of the recommendation result to the user profile and the search.

These and other embodiments will be evident from the present disclosure. It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

To easily identify the discussion of any particular element or act, the most significant digit or digits in a reference number refer to the figure number in which that element is first introduced.

FIG. 1 illustrates a network architecture used to search features to improve search results and user experience on a platform, according to some embodiments.

FIG. 2 is a block diagram illustrating details of devices used in the architecture of FIG. 1, according to some embodiments.

FIG. 3 is a block diagram illustrating an overview of an online reservation platform 300 implementing searching mechanisms, according to certain aspects of the present disclosure.

FIG. 4 is a block diagram illustrating a system flow for an autocomplete search feature designed to infer and provide optimal destination recommendations in an online reservation platform, according to certain aspects of the present disclosure.

FIG. 5 illustrates an example graphical user interface (GUI) displaying aspects of the autocomplete feature, according to certain aspects of the present disclosure.

FIG. 6 illustrates an exemplary table comprising information stored in a dataset and corresponding autocomplete results, according to certain aspects of the present disclosure.

FIG. 7 is a block diagram illustrating a system flow for an autosuggest feature designed to generate suggestions in an online reservation platform, according to certain aspects of the present disclosure.

FIGS. 8A-8B illustrate an example GUI displaying aspects of the autosuggest feature, according to certain aspects of the present disclosure.

FIG. 9 is a block diagram illustrating a system flow for a search expansion feature designed to generate alternative search results, according to certain aspects of the present disclosure.

FIG. 10 illustrates a workflow of the search expansion feature, according to certain aspects of the present disclosure.

FIGS. 11A-11D illustrate an example graphical user interface displaying carousels within a current search result generated by the search expansion feature, according to certain aspects of the present disclosure.

FIG. 12 is a block diagram illustrating an example system, according to certain aspects of the present disclosure.

FIG. 13 is a block diagram illustrating an example computer system with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a thorough understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### General Overview

Searching functionality on platforms, such as reservation or booking platforms, is a crucial component of user interactions. A significant number of unique users perform searches, leading to a high volume of total searches. However, users often encounter difficulties in conducting effective searches due to inadequate or complex search tools. This challenge is particularly evident where the uniqueness of each search result option adds to the complexity of the search process. Other searching challenges for users may include difficulty in navigating the search results on the page and encountering results that are not relevant to their needs. Improving search functionalities is essential to facilitate users in discovering optimal search results (for example, listings) efficiently.

Embodiments, as disclosed herein, provide a solution rooted in computer technology to the above-described technical problems in searching on platforms, namely, by providing search features to enhance the user search experience on a platform. The search features may include a search autocomplete feature, autosuggest feature, and search expansion feature. The search features may be implemented within a search engine of the platform. The search engine may include one or more sections designed to guide or present results of the search features.

The platform may provide search results (for example, including listings or bookings) to users, using the various search features, based on a dataset. The dataset may comprise of a data lake of global-travel centric locations including, but not limited to, cities, towns, landmarks, neighborhoods, attractions, and/or other destinations. According to embodiments, the search features may present destinations that are localized, ranked, and personalized to the user, further improving the quality of search results. Suggested destination personalization may be based on metadata or signals derived from user behavior, user account details, reservation history, etc.

According to embodiments, the search features may implement ranking algorithms to determine optimal rankings for destinations within a user interface (UI). The ranking may include generating a ranking score for each location in a set of suggested destinations. In some implementations, the rankings are personalized to users. The search features may include nested suggestions associated with a primary suggestion. One or more suggested destinations may be nested within another suggested destination based on, for example, ranking scores, locations, category, context, metadata associated with the locations, popularity, or the like.

According to embodiments, the autocomplete feature may determine suggested destinations for a search based on a user search input. The autocomplete feature may infer intended destinations from a partial input from the user (for example, the start of a search input including one or more characters for a desired destination) and display suggestions based therefrom. The autocomplete feature leverages the dataset to allow users the ability to search for places, cities, landmarks, points of interest, etc., around the world and view a set of other relevant locations listed for consideration based on their input. Selecting a suggested destination may execute a search based on the selection. The platform will then determine listings for the user to consider within the chosen suggested destination.

The autosuggest feature may determine destination suggestions based on user information and/or user profile including, but not limited to, language preferences, registered locations, booking history, prior searches, etc. The autosuggest feature leverages the dataset to provide personalized destination suggestions for the user to select from. This is different from the autocomplete feature as a user input is not required to trigger the destination suggestions. The autosuggest feature may include recent searches, recent property detail pages (PDPs), and suggested destinations. The autosuggest feature results may be implemented on a search page, providing quick access to suggested destinations, searches, and/or listings. In some implementations, recommendations from the autosuggest feature are limited to destinations, searches, and/or listings from a previous search session (that is, a latest session), a set of previous search sessions (for example, the last three sessions, sessions within the past month, etc.), a trend in searches input by the user (for example, the user has recently been searching for locations within Europe), or other signals.

According to embodiments, the search expansion feature may be configured to help guests find alternative results, in addition to their original search conditions. The search expansion feature may use techniques like flexible date recommendations, suggested filter removal, and split stays, etc., to identify alternative results. This improves the usability of a search by offering results based on varied or enhanced search parameters.

In some embodiments, the search expansion may include a carousel listing that provides suggestions based on a current search or previous searches. In some implementations, the carousel listing includes listings with one or more attributes of the current search flexed to provide alternative suggestions for the user to consider. The flexed attributes may be based on, for example, an analysis of available listings in response to the current search. In this manner, if search results are limited based on, for example, overly limiting filters or search requirements input by the user, the platform may generate similar listings that the user may be interested in. The carousel listings may include a flexible location carousel (for example, nearby destinations, popular destinations, or weekend getaways), flexible price carousel (for example, expanding or narrowing a selected price range for listings within a search result), filter removal carousel (for example, adding or removing filters for listing eligibility in a search), similar weekends carousel, or flexible dates (for example, flex monthly stays by +/−14 days and weekly stays by +/−2). The carousel listing may implement ranking optimizations to determine carousel placement (that is, ranking a carousel when multiple qualify/apply to the user) and ranking listings within each carousel.

In some implementations, the search expansion feature may further include suggesting personalized filters for modifying an executed search. By non-limiting example, filters may be recommended based on prior filter usage, or user account settings (for example, suggest filtering based on host language if the user has a preferred language). In some implementations, the search expansion feature may further include bundled filter recommendations. For example, filters that guests often use together may be bundled into one (such as, by non-limiting example, washer/dryer, step-free, pool/hot tub).

According to some embodiments, the platform may implement back navigation techniques based on user intent and a previous landing page. For example, a back navigation function performed (for example, in response to a user selecting a back button) on a PDP of a selected listing may return the display to the search results corresponding to that listing. In some implementations, users may select a recommended listing or experience in a specified destination via an external application or source (for example, an advertisement on the web for a listing on the platform). Accordingly, the back navigation function may direct the user to search results based on the selected recommended listing. Aspects of the search, such as dates, location, guest count, etc., may be auto filled based on the selected recommended listing and user information. According to some embodiments, the back navigation returns to previous pages sequentially. By non-limiting example, a current search (P1) may be executed, the user may select a flex date recommendation provided within a first carousel (P2), and then the user may select a flex location recommendation within a second carousel (P3). The back navigation may return to the various pages sequentially based on the back navigation function being executed (that is, from P3 to P2 and then P2 to P1). By non-limiting example, the user may back navigate from a flex date search PDP to the original dated search within the current search. Accordingly, the back navigation techniques provide guests with intuitive back navigation and minimize friction for searchers.

While some examples of the disclosure are specific to an online reservation platform, it will be understood and appreciated by those of ordinary skill in the art that the search improvement features described herein may be applied to other platforms including a search interface. The scope of the disclosure is not limited to the specific embodiments described, but rather extends to any modifications and variations that fall within the scope of the scope and knowledge of those skilled in the art.

In particular embodiments, privacy policies may limit the types of user data that may be collected, used, or shared by particular processes of the platform or other processes (for example, internal research, ranking algorithms, machine-learning algorithms) for a particular purpose. The platform may present users with an interface indicating the particular purpose for which user data is being collected, used, or shared. The privacy policies may ensure that only necessary and relevant user data is being collected, used, or shared for the particular purpose, and may prevent such user data from being collected, used, or shared for unauthorized purposes.

Several implementations are discussed below in more detail in reference to the figures.

### Example Architecture

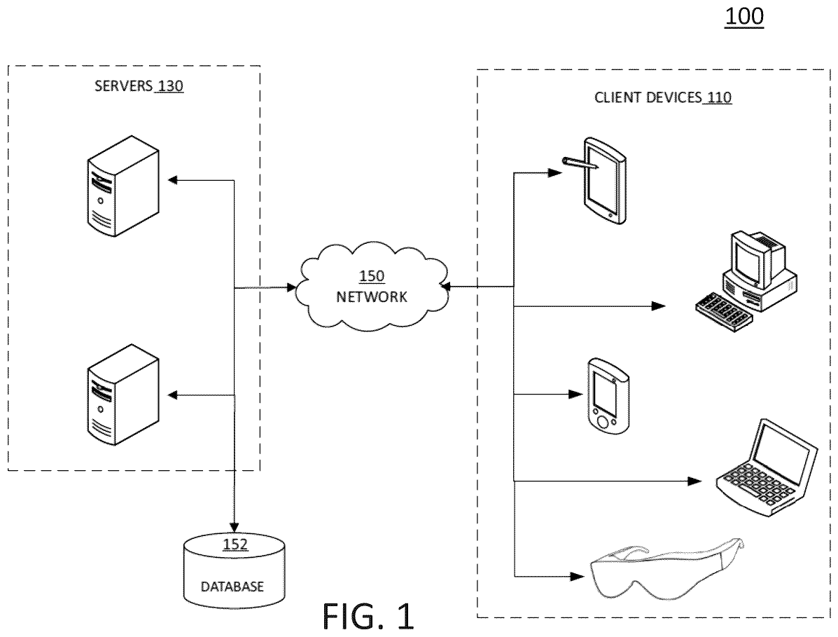

FIG. 1 illustrates a network architecture 100 used to search features to improve search results and user experience on a platform, according to some embodiments. Architecture 100 may include server(s) 130 and a database 152, communicatively coupled with one or more client devices 110 via a network 150.

Client devices 110 may include any one of a laptop computer, a desktop computer, or a mobile device such as a smart phone, a handheld device, video player, or a tablet device. Client devices 110 include a user interface that allows the user to interact with the platform. Client devices 110 may be configured with a web browser or a dedicated application to facilitate communication with servers 130.

Servers 130 may include a computing device or a cluster of computing devices that host the platform, service, or application running on client devices 110 used by one or more of the participants in the network. Servers 130 may include a cloud server or a group of cloud servers. In some implementations, servers 130 may not be cloud-based (that is, platforms/applications may be implemented outside of a cloud computing environment) or may be partially cloud-based. Servers 130 may be configured to receive requests from a client device, process the requests, and send appropriate responses back to the client device. Servers 130 may include a database for storing data, platform content, and other relevant information.

The database(s) 152 may store backup files from the platform required to run software including, for example, specific operating systems, CPU types, or installed software libraries that enable the execution of various programs on client devices 110. The database(s) 152 may logically form a single unit or may be part of a distributed computing environment encompassing multiple computing devices that are located within their corresponding server, located at the same, or located at geographically disparate physical locations. For example, various information related to listings, filters, localization data, user preferences, or the like may be stored in the database(s) 152.

Network 150 can include, for example, any one or more of a local area network (LAN), a wide area network (WAN), the Internet, a mesh network, a hybrid network, or other wired or wireless networks. Further, network 150 can include, but is not limited to, any one or more of the following network topologies, including a bus network, a star network, a ring network, a mesh network, a star-bus network, tree or hierarchical network, and the like. Network 150 may be the Internet or some other public or private network. Client computing devices can be connected to network 150 through a network interface, such as by wired or wireless communication. The connections can be any kind of local, wide area, wired, or wireless network, including the network 150 or a separate public or private network.

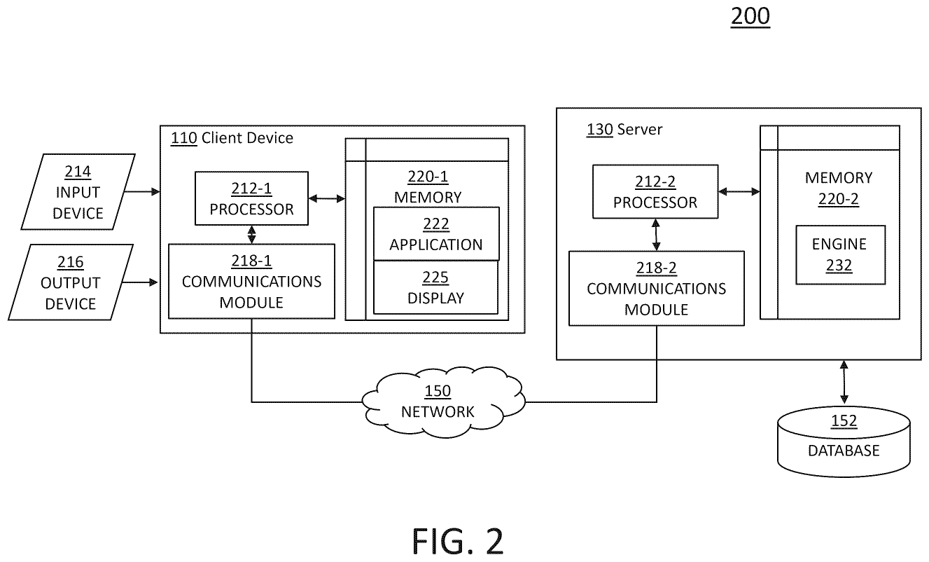

FIG. 2 is a block diagram 200 illustrating details of a client device 110 and server 130 used in a network architecture as disclosed herein (for example, architecture 100), according to some embodiments. Client device 110 and servers 130 are communicatively coupled over network 150 via respective communications modules 218-1 and 218-2 (hereinafter, collectively referred to as “communications modules 218”). Communications modules 218 are configured to interface with network 150 to transmit or receive information, such as user data, messaging history, user input data, and/or the like to other devices on the network 150. Communications modules 218 can be, for example, modems or Ethernet cards, and may include radio hardware and software for wireless communications (for example, via electromagnetic radiation, such as radiofrequency—RF—, near field communications—NFC—, Wi-Fi, and Bluetooth radio technology).

A user may interact with client device 110 via the input device 214 and the output device 216. Input device 214 may include a mouse, a keyboard, a pointer, a touchscreen, a wearable input device (for example, a haptics glove, a bracelet, a ring, an earring, a necklace, a watch, etc.), a microphone, a controller, a joystick, a virtual joystick, a camera, a touchscreen display that a user may use to interact with client device 110, or the like. In some implementations, the user provides search characters for a destination using the input device 214. In some embodiments, input device 214 may include cameras, microphones, and sensors, such as touch sensors, acoustic sensors, inertial motion units—IMUs—and other sensors configured to provide input data. Output device 216 may include a screen display (for example, an LCD display screen and/or LED display screen), a touchscreen, a speaker, a projector, holographic or augmented reality display (such as a heads-up display device or a head-mounted device), and/or the like.

In further examples, input device 214 and the output device 216 may include biometric components, motion components, environmental components, or position components, among a wide array of other components. For example, the biometric components include components to detect expressions (for example, hand expressions, facial expressions, vocal expressions, body gestures, or eye-tracking), measure biosignals (for example, blood pressure, heart rate, body temperature, perspiration, or brain waves), identify a person (for example, voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including electroencephalography (EEG) based BMIs, which record electrical activity in the brain using electrodes placed on the scalp, invasive BMIs, which used electrodes that are surgically implanted into the brain, and optogenetics BMIs, which use light to control the activity of specific nerve cells in the brain.

Any biometric data collected by the biometric components is captured and stored only with user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

In some embodiments, client devices 110 may include a headset or other wearable device (for example, a virtual reality or augmented reality headset or smart glass). In various implementations, client devices 110 can communicate over wired or wireless channels to distribute processing and/or share data. Architecture 100 can create, administer, and provide interaction modes for a shared artificial reality environment (for example, collaborative artificial reality environment) at client devices 110, such as for communication via XR or other communication elements. The interaction modes can include various modes for various audio conversation, textual input/output, communicative gestures, control modes, and other communicative interaction, etc., for each user of the client devices 110.

Client device 110 may also include a processor 212-1, configured to execute instructions stored in a memory 220-1, and to cause client device 110 to perform at least some operations in methods consistent with one or more embodiments and some operations are offloaded to a core processing component or server 130. Memory 220-1 may further include an application 222 and a display 225, configured to run in client device 110 and couple with input device 214 and output device 216. The application 222 may be downloaded by the user from servers 130 and may be hosted by servers 130. The application 222 includes specific instructions which, when executed by processor 212-1, cause operations to be performed according to methods described herein. In some embodiments, the application 222 runs on a platform, for example, an operating system (OS) installed in client device 110. In some embodiments, application 222 may run out of a web browser. In some embodiments, the processor is configured to control a graphical user interface (GUI) or display 225 for the user of one of client devices 110 accessing the server of the platform. Data and files associated with the application 222 may be stored in database(s) 152.

Server 130 includes a memory 220-2, a processor 212-2, and communications module 218-2. Hereinafter, processors 212-1 and 212-2, and memories 220-1 and 220-2, will be collectively referred to, respectively, as “processors 212” and “memories 220.” In some implementations, the servers 130 can be used as part of a social network/platform implemented via the network 150. Processors 212 (for example, CPUs, GPUs, holographic processing units (HPUs), etc.) are configured to execute instructions stored in memories 220. The processors 212 can be a single processing unit or multiple processing units in a device or distributed across multiple devices (for example, distributed across two or more of client devices 110). The processors 212 can be coupled to other hardware devices, for example, with the use of an internal or external bus, such as a PCI bus, SCSI bus, wireless connection, and/or the like. The processors 212 can communicate with a hardware controller for devices, such as input device 214 and output device 216.

Memories 220 include one or more hardware devices for volatile or non-volatile storage, and can include both read-only and writable memory. For example, a memory can include one or more of random-access memory (RAM), various caches, CPU registers, read-only memory (ROM), and writable non-volatile memory, such as flash memory, hard drives, floppy disks, CDs, DVDs, magnetic storage devices, tape drives, and so forth. Memories 220 are not propagating signals divorced from underlying hardware; a memory is thus non-transitory. The memories 220 can include program memory that stores programs and software. The memories 220 can also include data memory that can include information to be provided to the program memory or any element of the network.

Memory 220-2 may include a search engine 232 which may share or provide features and resources to display 225, including multiple tools associated with text, image, or video collection and capture. These tools may support design applications that use images or pictures retrieved (for example, at application 222) for content rendering to a user of client device 110. This enables the platform to present listings, user reviews, and other relevant content effectively to the user. The user may access the search engine 232 through application 222, installed in a memory 220-1 of client device 110. Accordingly, application 222, including display 225, may be installed by servers 130 and perform scripts and other routines provided by servers 130 through any one of multiple tools. Servers 130 may include an application programming interface (API) layer, which controls applications in the client device 110. API layers may also provide tutorials to users of the client device 110 as to new features in the application 222. Search engine 232 may include one or more sets of machine-readable instruction modules that, when executed by processors 212, are configured to perform operations according to one or more aspects of embodiments described herein.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, and/or the like.

The techniques described herein may be implemented as method(s) that are performed by physical computing device(s); as one or more non-transitory computer-readable storage media storing instructions which, when executed by computing device(s), cause performance of the method(s); or as physical computing device(s) that are specially configured with a combination of hardware and software that causes performance of the method(s).

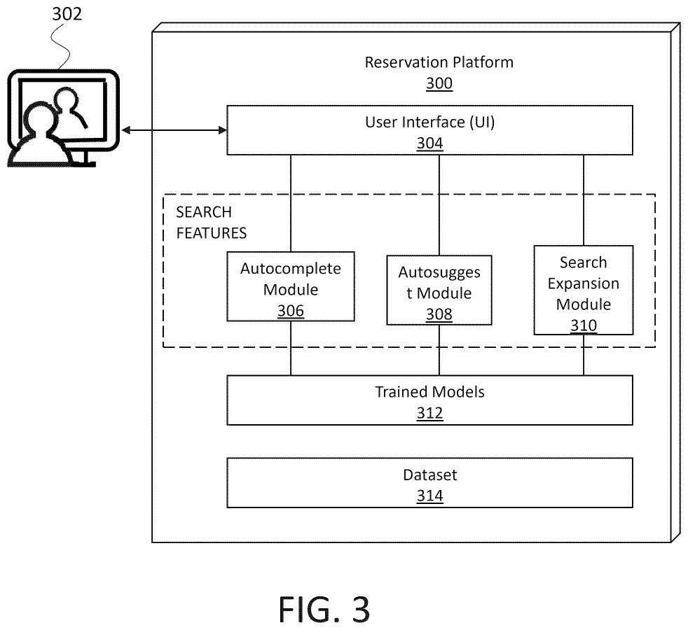

FIG. 3 is a block diagram illustrating an overview of an online reservation platform 300 implementing searching mechanisms according to one or more embodiments. The online reservation platform 300 may be a software system designed to facilitate the reservation or exploring of listings, experiences, or the like, in different locations over the internet.

The platform 300 includes a front-end user interface (UI) 304 facilitating user 302 interactions with the platform 300. The UI 304 may include web pages or mobile app screens where users can search for destinations, select dates and times, and enter other details to narrow their desired request. The UI 304 may communicate with a search engine of the platform 300 and process user requests and reservations, check for qualifying listings in a dataset 314, and enhance listings provided to the user 302.

According to embodiments, the dataset 314 is a travel centric dataset comprising global locations developed and maintained by the platform 300. The platform 300 uses the dataset 314 to allow users the ability to search for places, cities, landmarks, points of interest, etc., around the world. The dataset 314 may be created by the platform 300 by collecting data from multiple sources including, but not limited to, web pages, and user inputs. In some embodiments, the dataset 314 may be structured into a predefined format and indexed. The indexing may include generating indices for data points (for example, locations) based on the structured data. Each index entry may include, but is not limited to, a unique identifier (ID), descriptive information (for example, name, type of location, etc.), a category, a reference to a data source, and additional metadata about each data point. In some implementations, the dataset 314 includes a knowledge graph representing connections and relationships between data points. This knowledge graph can also incorporate tables to organize and display structured data.

The platform 300 may determine a set of organic search results (that is, search results from the user's direct search) by referencing the dataset 314. The platform 300 may then implement search features to enhance the search results using trained models 312. The trained models 312 may be trained based on click history, locations, reservation history, search history, language models, or the like, to provide personalization capabilities to the search features. The trained models 312 may support various language inputs/outputs. The trained models 312 may include data localization model(s), datapoint ranking model(s), datapoint nesting model(s), listing inventory tracking models, or the like. The trained models 312 are used to simplify search and/or search result accessibility and usability (for example, through back navigation, providing recent searches, recent PDPs, etc.). As such, the trained models 312 are leveraged to provide highly relevant, personalized destination and listing suggestions, simplifying the process for guests to resume a search journey and complete a booking.

Autocomplete module 306 may infer desired locations, destinations, landmarks, etc., based on a user's search input. The locations may be identified via the dataset 314. Autosuggest module 308 may generate location or search recommendations for the user 302 to explore. The autosuggest module 308 recommendations may include suggestions for recent searches, destination suggestions, recent listings (for example, PDPs), filters, or the like. The autosuggest module 308 may be designed to provide quick click access to suggestions (for example, upon startup of a search page on the platform 300).

Search expansion module 310 may be configured to provide further explorative listing suggestions to the user by modifying one or more aspects of the user's search. The search results from searches with modified search parameters may be provided to the user 302 using an interactive carousel of listings. For example, search expansion module 310 may determine that a current search provides results that are suboptimal and by flexing a start date or guest count, the user 302 can explore more optimal listing selections. Therefore, the search expansion module 310 may generate a carousel listing including search results with the current search parameters and a flexible start date, enabling new search results for consideration.

According to embodiments, search results may be provided to the user 302 via the UI 304. Users may execute searches, select listings, explore recent searches, or the like, via the UI 304. The user 302 may modify an existing search to generate updated search results. The user 302 may initiate new search sessions, a predetermined set of which may be stored and retrieved at another time by the platform 300. Embodiments described herein provide improvements to a search process by providing search features on a homepage of the platform, a search page (presented when initiating a search), search results page, and/or PDPs.

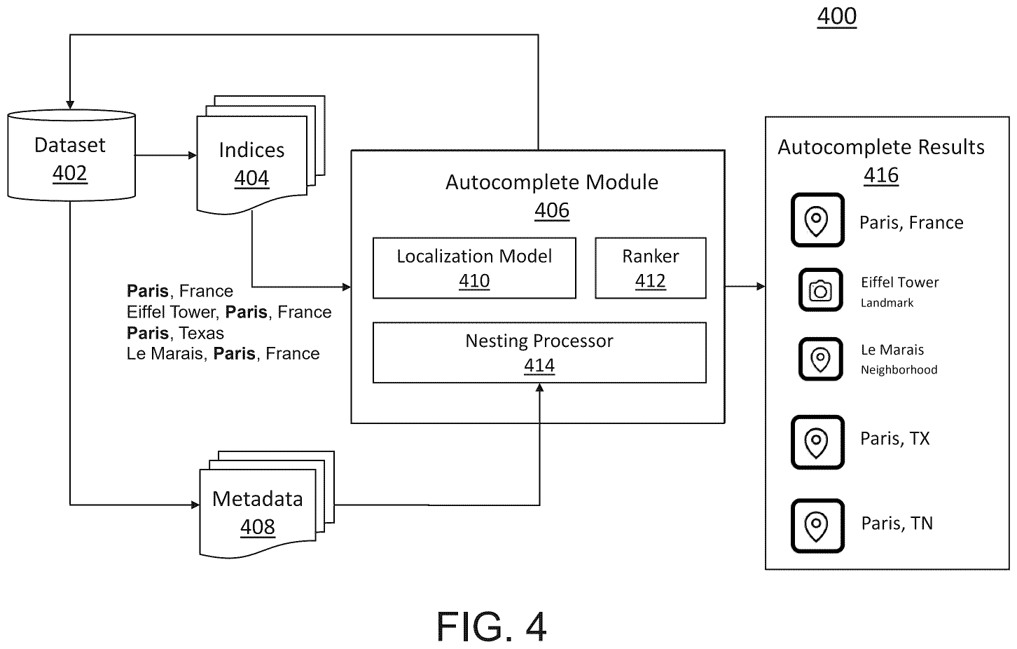

FIG. 4 is a block diagram illustrating a system flow 400 for an autocomplete search feature designed to infer and provide optimal destination recommendations in a search engine (for example, search engine 232) of an online reservation platform (for example, platform 300), according to one or more embodiments. The autocomplete feature, implemented by autocomplete module 406, may provide suggested destinations based on a user's input (for example, the start of a user search or a partial user search input) on a search page. The autocomplete module 406 may be implemented using machine learning models in a machine learning system.

A user may input, for example, “Paris” as a search input to the search engine of the platform via a client device (for example, client device 110). The search input may be processed using a dataset 402 (for example, dataset 314) of locations to determine a set of suggested destinations. The set of suggested destinations may be retrieved from the dataset 402 as indices 404. That is, indices 404 are identified from the dataset 402 based on the search input. In the example of FIG. 4, the indices 404 may include, based on search input “Paris”: “Paris, France”; “Eiffel Tower, Paris, France”; “Paris, Texas”; and “Le Marais, Paris, France.” The set of suggested destinations are then processed by the autocomplete module 406.

According to embodiments, the autocomplete module 406 may include a localization model 410. The localization model 410 may be configured to localize locations and toponyms in the dataset to different languages, regions, and cultural contexts. The localization model 410 enables the platform to support various language inputs. This ensures that the suggestions provided by autocomplete module 406 are relevant and accurate for users in various locales. In some implementations, the localization model 410 may include tailoring names or descriptors of suggested destinations to match local naming conventions, addresses, and points of interest. The localization model 410 may be configured to detect duplicates in naming between different languages and remove the duplicates.

The localization model 410 may implement localization of the suggested destinations. Accordingly, localized location strings may be displayed to the user to make it easier to identify and select locations. In some implementations, the localization may include, but is not limited to, shortening children node names, customizing icons displayed in association with the names, adding descriptors for children nodes, matching phrases in the set of suggested destinations, shortening names for cities with highest popularity, or the like.

According to embodiments, the localization model 410 may include LLMs for generating translations to provide toponyms in different languages (for example, Pinyin for Chinese; Hiragana and Romaji for Japanese). The localization may include, but is not limited to, translating names, points of interest, or the like, based on localized context. By non-limiting example, a name label for a suggested destination may be adjusted from “Tokyo, Tokyo Prefecture, Japan” to “Tokyo, Japan” to better suit localized context. By non-limiting example, a descriptor label for a suggested destination (for example, Shibuya) may be adjusted from “City” to “Ward” to better align with local naming conventions. In some embodiments, the autocomplete localization may include generating two-level results to be displayed in different languages based on location/region (for example, Chinese and Japanese).

According to embodiments, the autocomplete module 406 may include a ranker 412 configured to rank the set of suggested destinations using a trained ranking model. In some embodiments, the ranker 412 determines a ranking score for each of the suggested destinations based on any combination of features including, but not limited to, global popularity, regional popularity, match type, input-dependent popularity, or the like. The ranker 412 may implement a ranking model to generate ranking scores based on the features of the identified indices 404.

The rankings may be characterized by the ranking score. The ranker 412 may reorder any of the suggested destinations (that is, the indices 404) with minimum impact to the original ranking order based on the ranking scores. By non-limiting example, the ranker 412 may assign the following ranking scores to each of the indices 404: “Paris, France” a ranking score of 5; “Eiffel Tower, Paris, France” a ranking score of 0.5; “Paris, TX” a ranking score of −0.3; “Paris, TN” a ranking score of −0.5; and “Le Marais, Paris, France” a ranking score of −1.2. Although “Le Marais, Paris, France” may have the lowest ranking score, it may be more intuitive and improve the user experience to have “Le Marais, Paris, France” listed closer to its related suggested destinations (that is, “Paris, France” and “Eiffel Tower, Paris, France”). As such, the lowest ranking suggested destination may be moved up in the ranking to be displayed below its related highest ranking suggested destinations.

In some embodiments, the locations in the set of suggested destinations may be ranked based on account/user settings on the platform. By non-limiting example, the ranking may be based on user origin, age, travel history, search history and recency, or public information on the user and/or other users (for example, similar users based on origin, language preferences, etc.). In some implementations, locations may be ranked based on a user's latest clicked places (that is, selected destinations to execute a search or listing to view details of a listing). By non-limiting example, if a user previously selected a famous landmark, then the landmarks in/around a currently searched location may be ranked higher in a current autocomplete results list. In some implementations, locations may be ranked based on historic user engagement. By non-limiting example, if a user has gone to Paris, TX but never searched for Europe, Paris, TX may be ranked higher than Paris, France. As such, the ranker 412 may rank locations to provide relevant and personalized autocomplete searching during the search process for users.

In some embodiments, suggestions may be personalized and may be based on signals including, but not limited to, queries (that is, user search inputs), language, country, region, the user's click history (for example, last or previous clicked IDs), geo coordinates (including time or distance to a latest search), time of the search, search history, booking history, and/or other details on previous searches like places, selections, or the like. Before collecting click and search data from users for personalization, the platform will provide one or more opt-in interfaces to the user. The opt-in interfaces communicate to the user that the system is requesting to collect the user's click and search data and allow the user to opt in to the data collection or refuse to allow the system to collect the data. Upon receiving an affirmative consent from the user, the platform may provide personalized search suggestions—tailoring suggestions to individual users on the platform. Similarly, users may choose to opt out of personalized search suggestions (for example, remove the most recent searched-for place). The opt out option may be provided at the result level (for a particular location), at the session level (that is, applied to all searches in a session), or at the user level (that is, never or always show personalized results for the user).

In some embodiments, the personalization model may be an ML model configured to learn based on the relationship between previous clicked locations and current candidate locations (that is, suggested destinations). By non-limiting example, a relationship between previous clicked locations and the current candidate locations may involve determining whether there is a match or exact match between the most recent search (or similarly, any recent search comprising, for example, at least a specified number of previous searches). By non-limiting example, a relationship between previous clicked locations and the current candidate locations may involve determining whether there are nearby matches in suggested destinations. In some implementations, nearby matches may include supersets (for example, Los Angeles followed by California), subsets (for example, Costa Rica followed by Papagayo Peninsula), and nearby locations (for example, British Virgin Islands followed by US Virgin Islands). By non-limiting example, the relationship between previous clicked locations and the current candidate locations may involve analyzing location context types (for example, global, local, regional) and basing personalization on the context types. By non-limiting example, if a current user search input is a substring of a previously searched location, the platform may force previously searched locations to occupy a top position of the autocomplete results displayed to the user. In some implementations, the personalization may consider, for example, a previous session with multiple queries, a latest query, and/or a latest session when personalizing current autocomplete results.

According to embodiments, the autocomplete module 406 may including a nesting processor 414 configured to determine whether the indices 404 should include nested nodes based on the set of suggested destinations and associated metadata 408 stored in the dataset 402. The metadata 408 may include category, descriptors, toponyms, local/regional click count information, or the like. Locations (nodes) may be nested from a parent node. The nested results may include multiple children nodes nested under the parent node. By non-limiting example, the nesting processor 414 may determine that “Eiffel Tower,” “Paris, France” and “Le Marais, Paris, France” may be nested as children nodes of “Paris, France.”

In some implementations, children nodes may have customized icons, descriptors, shorter names (not full hierarchy), matching phrase highlights, shorter famous city names, etc.

In some embodiments, the nesting processor 414 may leverage the ranker 412 and localization model 410 to determine destinations to include in the nested results. By non-limiting example, certain countries or cities may have known or frequently visited landmarks. The nested results may be displayed based on place type of the original search having nodes within the place with at least a threshold for popularity (are these places well known enough to be displayed as a nested search result). In some implementations, the nested nodes are ranked based on their ranking scores generated by ranker 412. In some implementations, the nested nodes are ranked based on local/regional click count. For example, users of the platform may be statistically more likely to select landmarks over neighborhoods-thus, ranking Eiffel Tower higher than Le Marais.

In some implementations, the nested results may be provided when the first suggestion reflects a general user intent. General user intent may be determined based on the top two suggestions in the autocomplete results having a ranking score difference greater than or equal to a predetermined threshold. By non-limiting example, if the autocomplete results include a first suggestion with a ranking score of 4.1 and a second suggestion with a ranking score of 1.02, and the ranking score difference threshold is 3, then nested results corresponding to the first suggestion will be displayed to the user.

In some implementations, only parent nodes (without the nested results) are displayed when suggested destination ranking scores are within a predetermined range of each other (that is, suggestions having similar ranking scores). By non-limiting example, if a first suggestion in the set of suggested destinations has a ranking score of 2.77, a second suggestion has a ranking score of 2.71, and a third suggestion has a ranking score of 2.61 and the predetermined range is set to +/−0.2, the first, second, and third suggestions are displayed and nested suggestions are omitted from display.

According to some embodiments, the nested results may be triggered based on the first suggestion being a country, state, city, or island. In this instance, the nested results may correspond to POIs, landmarks, neighborhoods, or the like.

According to some embodiments, the nested results may be triggered based on at least one child node of the parent node being included in the first x suggestions in the autocomplete results (for example, top five suggestions). By non-limiting example, if x=5 and the autocomplete results include: “Paris, France”; “Park City, UT”; “Paros, Greece”; “Parker, AZ”; and “Paranaque City, Metro Manila, Philippines”; then, the first five suggestions do not include a child node of Paris, France. Therefore, the nested results will not be triggered. Embodiments are not intended to limit the possible combinations or value of suggestions, results, and score threshold. One of ordinary skill in the art would reasonably understand that any combination of techniques, values, and ranges may be applied together or separately to provide optimal autocomplete results to a user.

In some implementations, the autocomplete results may include a large score difference and children node candidates within the top ranked suggestions, and therefore, the nested results may be provided for the first suggestion. By non-limiting example, if x=5, the ranking score difference threshold is 3, and the autocomplete results include: Paris, France (ranking score 5); Eiffel Tower, Paris, France (ranking score 0.5); Paris, TX (ranking score −0.3); Paris, TN (ranking score −0.5); and Le Marais, Paris France (ranking score −1.2)—the first five suggestions include children nodes of Paris, France and the top two suggestions have ranking score differences over the threshold, and therefore the nesting processor 414 will be triggered.

According to embodiments, a displayed order of nested children nodes may be determined based on hierarchical location data. The hierarchical location data may be retrieved from one or more (external) data sources. By non-limiting example, children nodes may be ordered according to country, region, and city (for example, France, Île-de-France, Paris). According to embodiments, a displayed order of nested children nodes may be determined based on distance and/or location. By non-limiting example, a latitude and longitude of children nodes within a parent boundary may be listed higher in the order of nested children nodes. By non-limiting example, children nodes with a short (or longer) travel distance from the parent node may be displayed higher (or lower) in the order of nested children nodes.

In some implementations, the nesting processor 414 may include modifying nesting for a set of suggested destinations based on local identifiers. By non-limiting example, the autocomplete module 406 may modify, using the localization model 410, the suggested destination “Tokyo station, Chiyoda City, Tokyo, Japan” to “Tokyo Station” based on local name conventions. Further, nesting processor 414 may nest “Tokyo Station” under parent node “Tokyo, Japan” based on adjustments made by localization model 410.

The nesting processor 414 may also be personalized to the user. By non-limiting example, the user may have previously searched (within a predetermined time window) “France” in the search engine. Based on this, the autocomplete module 406 may retrieve and suggest more nested nodes (for example, Saint-Germain-des-Prés, Paris Orly Airport (ORY), etc.) for a contextually relevant parent node (for example, Paris, France). In some implementations, the added nested nodes may lower the display of potentially unrelated suggested destinations (for example, Paris, TX and Paris, TN) or be displayed in place of them. In some implementations, the personalization may consider historic user engagement as a feature. By non-limiting example, if the user has gone to Paris, TX and never searched for Europe, the ranker 412 may rank Paris, TX higher than Paris, France.

Based on the ranked, nested, personalized and/or localized suggestions, the autocomplete module 406 generates a set of autocomplete results 416 to be displayed at the client device of the user. As shown in FIG. 4, the autocomplete results 416 include, based on search input “Paris,” “Paris, France” as the first suggested destination having a relevant landmark, “Eiffel Tower,” and neighborhood “Le Marais,” nested therefrom, and second and third suggested destinations as “Paris, TX” and “Paris, TN.”

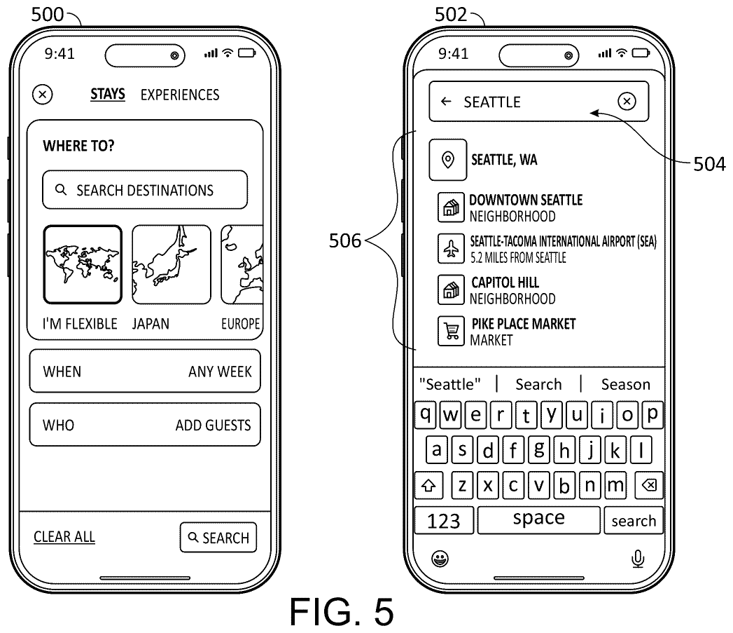

FIG. 5 illustrates an example graphical user interface (GUI) displaying aspects of the autocomplete feature according to one or more embodiments. Display 500 illustrates a search page on the platform. A user may enter a search query via the search page. Display 502 illustrates a search query 504 “Paris” entered by the user and a set of autocomplete results 506 generated based on the search input. As shown in FIG. 5, Seattle, WA is generated as a first suggestion and parent node to a set of children nodes including Downtown Seattle, Seattle-Tacoma International Airport, Capitol Hill, and Pike Place Market.

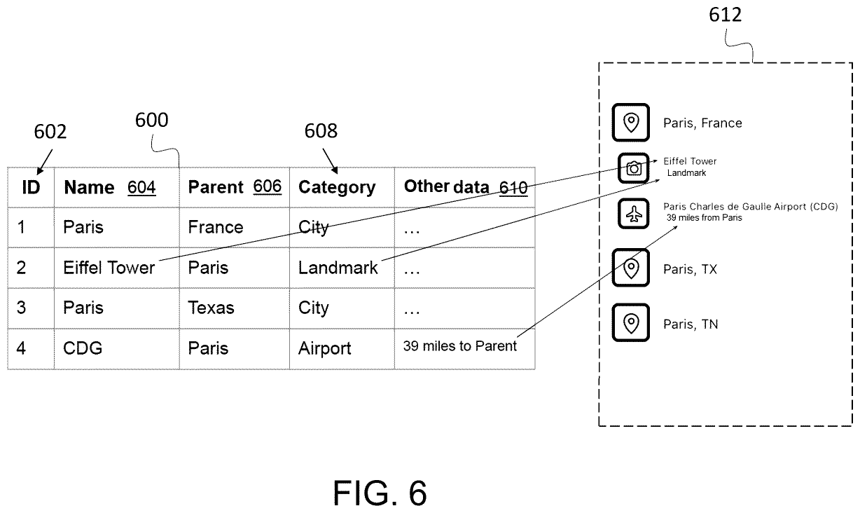

FIG. 6 illustrates an exemplary table 600 comprising information stored in a dataset (for example, dataset 402) and corresponding autocomplete results 612, according to one or more embodiments. According to some embodiments, nested results may be triggered based on items in a set of suggested destinations (for example, represented by indices 404). Children nodes may be nested based on attributes of the set of suggested destinations stored in the dataset. Items in the dataset may include, but are not limited to, a unique ID 602, name 604, parent information 606, category 608, and/or other data 610 (for example, distance from parent).

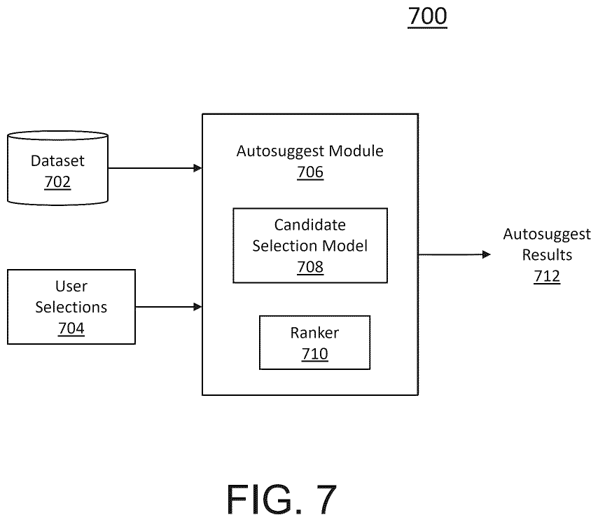

FIG. 7 is a block diagram illustrating a system flow 700 for an autosuggest feature designed to generate suggestions in a search engine (for example, search engine 232) of an online reservation platform (for example, platform 300), according to one or more embodiments. The autosuggest feature, implemented by autosuggest module 706, may provide 1-click access to suggestions for recent searches, suggested destinations, and recent PDPs for the use to explore. The autosuggest module 706 may be implemented using machine learning models in a machine learning system.

The suggestions may correspond to recent searches, suggested destinations, and recent PDPs that have been viewed by the user but not booked. This enables users to easily find and continue with a prior search, easily modify a current search, and/or explore new and relevant destinations. The recent searches may include descriptors providing additional details and context on the searches including, but not limited to, dates, guest count, or other filter parameters, such as city, state, region, or the like. The recent PDPs may include booking details such as dates, guest count, amenities, or the like. Destination suggestions may include names, suggested dates, attributes (for example, popularity), relation to the user (for example, destination from Wishlist), and/or other details.

The autosuggest module 706 leverages the dataset 702 (for example, dataset 314) and user destination and listing selections 704 (hereafter referred to as “user selections 704”) to provide personalized suggestions from the user's previous search session(s) for the user to select from. This is different from the autocomplete feature as a current user input is not required to trigger the suggestions provided by the autosuggest module 706. The autosuggest results 712 may be automatically displayed on a search page, providing quick access to suggested destinations, searches, and/or listings.

The candidate selection model 708 may be configured to determine which recent searches, recent PDPs, and/or destination suggestions qualify for display upfront on the search page. The qualifying recommendations are selected as candidates for display—from which the ranker 710 will further process for the autosuggest module 706 to arrive at a final suggestion. According to some embodiments, the candidate selection model 708 may determine candidates based on user engagement (for example, interactions with listings, initiating checkout/booking, view times, etc.). In some implementations, the candidate selection model 708 limits destinations, searches, and/or listings to those from a previous search session (that is, a latest session), a set of previous search sessions (for example, the last three sessions, sessions within the past month, etc.), a trend in searches input by the user (for example, the user has recently been searching for locations within Europe), or other signals. In some implementations, the candidate selection model 708 excludes recent PDPs that are no longer available for prior dates and a guest count (as previously selected by the user) from the search page.

In some embodiments, when determining which recent PDPs to display to the user, the candidate selection model 708 may filter out PDPs viewed before a last location search. In some embodiments, the candidate selection model 708 may focus on viewed listing that were not booked within a specific timeframe (for example, X seconds). The candidate selection model 708 may group viewed PDPs by listing ID and select a most recent view per listing. In some embodiments, the candidate selection model 708 may sort PDPs by timestamp in descending order. The candidate selection model 708 may limit a set of candidate PDPs to a threshold (for example, take up to 15 candidate PDPs).

According to some embodiments, the candidate selection model 708 may determine PDP candidates to be suggested based on user information and/or user profile including, but not limited to, language preferences, registered locations, booking history, prior searches, etc.

According to embodiments, the candidate selection model 708 may select searches, destinations, or listings for recommendation based on location type. By non-limiting example, cities may be optimal for recommendations over small regions/provinces/islands (for example, Bali, Lake Como, Maui, etc.) so as to not overly limit a user's options, and therefore may be identified as candidates for recommendation over the later.

According to embodiments, selecting a recent search on the search page will execute the search with prior location, dates, guests and filters preserved. As such, the user can easily continue where they left off. According to embodiments, selecting a recent PDP on the search page will show the PDP with prior dates and guest count preserved.

The autosuggest module 706 may include a ranker 710 configured to rank the candidates (identified by candidate selection model 708) and display the top ranked results. The ranker 710 may rank candidates based on heuristics. In some implementations, the ranker 710 may be the same as or similar to ranker 412. The rankings may be based on ranking scores generated by the ranker 710. In some implementations, the ranker 710 extracts features associated with the candidates, including but not limited to, user features, listing features, user engagement features, search features, or the like. Candidates may be ranked based on features and sorted by score (for example, descending). Features of listings may include, but are not limited to, highlights including, for example, accessibility, category, and location highlights including, but not limited to, the listing having a nearby playground, being walking distance from a landmark, cost of booking, etc. In some embodiments, the ranker 710 may filter PDP candidates that have a ranking score below threshold or unavailable listings.

The ranker 710 prioritizes and ranks candidates for recent searches, recent PDPs and/or suggested destinations based on user intent. As such, the displayed recommendations are not merely showing abandoned PDPs and instead present more relevant and personalized suggestions catered to the user. According to some embodiments, user intent may be determined using a deep learning or neural network-based model inference configured to analyze different signals based on user attributes and/or engagement (for example, time spent on a search, listing selections, search inputs, recent user searches, past trip signals, user profile, Wishlist items, saved items, etc.), destination attributes, listing attributes, or the like, to determine user intent. By non-limiting example, recent searches generated as a product of a search input from the user may be considered to have higher intent compared to a recent search generated as a product of the user selecting a suggested destination (generated by the autosuggest module 706).

In some implementations, the autosuggest module 706 may identify an abandoned PDP (for example, a listing a user selected but did not submit for booking) with highest user intent and provide quick access to said PDP. By non-limiting example, the user may have selected to view a listing multiple times within a certain time window, indicating increased interest in the respective PDP. As another non-limiting example, the user may have selected a listing and followed through to the booking step but failed to complete the booking within a predetermined timeframe. As another non-limiting example, the user may have spent an increased period of time viewing the listing compared to other listings in the same search or session. By providing quick access to high intent listings, the platform can significantly improve listing recovery and streamline the booking process.

According to some embodiments, the ranker 710 returns one or a subset of the candidate PDPs. From the subset of candidates, the autosuggest module 706 may pick one (that is, a final suggestion) PDP for display based on the ranking.

According to some embodiments, the autosuggest module 706 may also be configured to control back navigation between searches, PDPs, and destination suggestions. The autosuggest module 706 may implement back navigation techniques based on user intent and a previous landing page. For example, a back navigation function performed (for example, in response to a user selecting a back button) on a PDP may return the display screen to the search results corresponding to that listing.

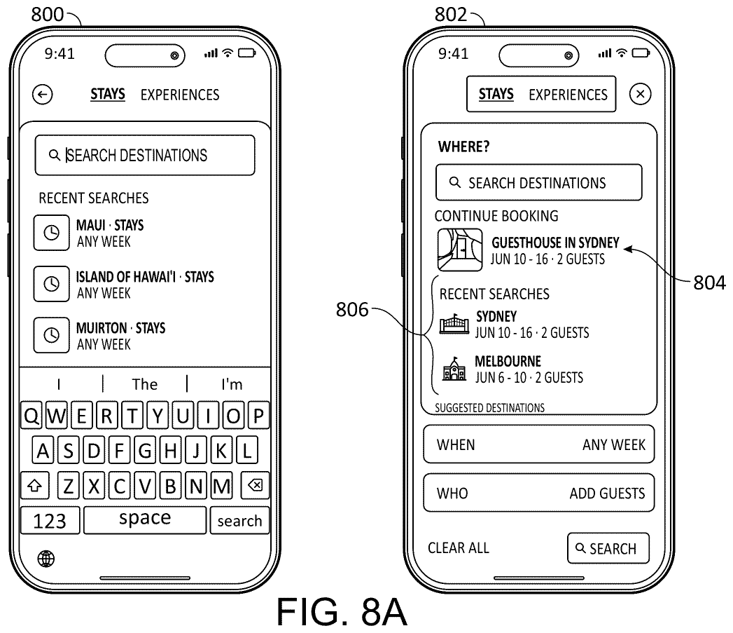

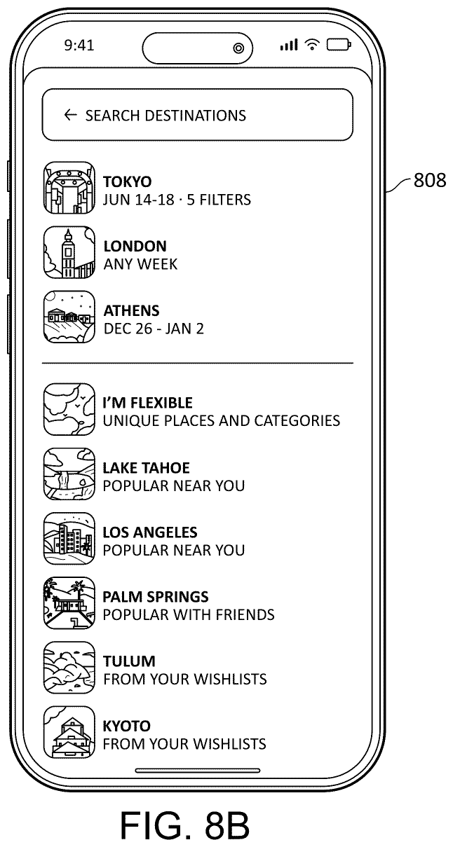

FIGS. 8A-8B illustrate an example GUI displaying aspects of the autosuggest feature, according to one or more embodiments. As shown in FIG. 8A, display 800 shows recent searches, providing 1-click access in a search page. The recent searches may be displayed prior to a user inputting a search query. Display 802 shows a PDP 804 which the user can select to continue with a booking process for the corresponding listing. The PDP 804 may correspond to, for example, a listing the user started a booking process for and failed to complete in a previous session. The display 802 also shows a set of recent searches 806. FIG. 8B illustrates a display 808 including suggested destinations recommended for the user.

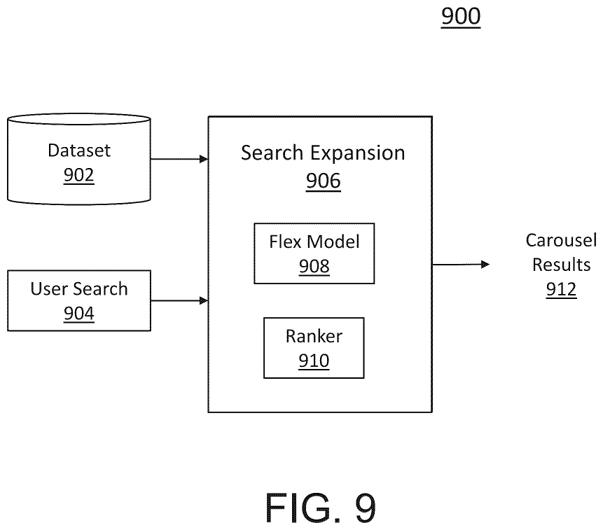

FIG. 9 is a block diagram illustrating a system flow 900 for a search expansion feature designed to generate alternative search results, according to one or more embodiments. The alternative search results may be displayed in a carousel within results of a search (hereafter “current search results”). The search expansion feature, implemented by search expansion module 906, may include a flex model 908 and a ranker 910. The search expansion module 906 may be implemented using machine learning models in a machine learning system. The search expansion module 906 may leverage a dataset 902 (for example, dataset 314) and a user search 904 to provide personalized search expansion to optimize search results.

The flex model 908 may be configured to relax or flex one or more parameters of a search to identify recommendation results based on a pivot search having the relaxed/flexed parameter. The listings derived from the pivot search provide alternative results for the user to explore in a carousel. The flex model 908 may flex a search to offset check-in/checkout days, total price, total nights, location, amenities, listing features, filters, time (for example, similar weekend), proximity (for example, results for neighboring cities), etc. The flex model 908 may be trained to determine which aspects of the user search 904 to flex based on the query, search results (for example, total number of listings in the search results, each individual listings' price, location, review, etc.), inventory (for example, available listings outside of the user's exact search parameters), contextual data (for example, user preferences and context on the search location), or the like.

According to embodiments, the flex model 908 may generate multiple candidate carousels including the recommendation results—each of the candidates having a different parameter relaxed/flexed based on the search. By non-limiting example, the flex model 908 may generate a first recommendation results for a first carousel by flexing a date on the search to set a new date range (for example, flex check-in and/or checkout date by +/−1 day). By non-limiting example, the flex model 908 may generate a second recommendation results for a second carousel by relaxing a price for listings in the search (for example, increasing the allowed price range for the search+/−5%). By non-limiting example, the flex model 908 may generate a third recommendation results for a third carousel by relaxing amenities for listings in the search (for example, removing the requirement for a pool in the search).

According to some embodiments, the search expansion module 906 may refine the multiple candidate carousels by predicting relevance of the different carousel compared with the organic search result. A model of the search expansion module 906 may predict relevance based on features including, but not limited to, a user's current query conditions (for example, lead days, length of stay, guest count, destination, distance, etc.), organic search result), recommended listing from recommendation results in each carousel, booking history (for example, long term past bookings), recent searches (for example, the user may have already searched different dates, different locations, viewed different listings), user engagement (for example, engagement/non-engagement on the different recommended carousels presented in recent searches for different search conditions).

The features may be used to better determine the user's intent and relevance of the candidate carousels. By non-limiting example, some flex options are more useful in short length of stay (for example, 1-2 days) vs. longer stays (for example, above 5 days). By non-limiting example, the flex model 908 may be more likely to provide an increased number of carousels for a search with shorter lead days as the inventory may be lower, or when total organic results are lower than a threshold, or the like.

According to some embodiments, a filter carousel is generated for searches where an associated filter is applied and there are listings that are better than the organic search result (that is, search results that match the user search input). By non-limiting example, a flex price carousel is only displayed to the user when the search includes a price filter applied therein and the search expansion module 906 identifies one or more listings with higher relevance to the user but may have a price outside the user requested range from their search.

According to some embodiments, the search expansion module 906 may include filter improvement recommendations based on a current search. The filter improvement recommendations may be displayed in a filter page which may be triggered by a user indicating intent to modify a current search. In some implementations, the search expansion module 906 provides suggested filters for the user (the same or different from filters removed or flexed in carousels generated based on the current search). The suggested filters may be personalized to the user and selected to modify an executed search. By non-limiting example, filters may be personalized and recommended based on prior filter usage, user account settings (for example, suggest filtering based on host language if the user has a preferred language). In some implementations, the filter improvement recommendations may further include bundled filter recommendations. For example, filters that guests often use together may be bundled into one (such as, by non-limiting example, washer/dryer, step-free, pool/hot tub).

In some implementations, the filter improvement recommendations of the search expansion module 906 provides quick filter removal suggestions, allowing the user to see what filters they have applied to the current search and a quick way to remove one or more of them to access more quality listings. In some implementations, the search expansion module 906 provides less relevant features in a collapsed section of the filters. Less relevant filters may be identified as filters that the user does not historically use, filters that would result in an overlay narrow search with limited inventory (for example, less than a threshold number of listings), user preferences (for example, user profile may indicate accessibility needs, language preferences, or the like. Thus, those filters may automatically be applied and placed in a collapsed section).

According to some embodiments, the search expansion module 906 may including a refinement model to remove candidate carousels prior to ranking and provide a refined set of carousels for further processing (for example, by ranker 910). For example, the search expansion module 906 may limit the type of carousel displayed to no more than once per search session. This will avoid showing repetitive types (for example, price flex, location flex, or amenities flex, etc.) of carousels. As such, the search expansion module 906 does not apply and show multiple carousels with same type of relaxations within a single search session.

The ranker 910 may be configured to rank carousels and rank the recommendation results (that is, listings within carousels) using a ranking model based on, for example, booking preferences. The carousel ranking model may compare if users are more likely to book a listing from organic search result, or more likely to book a listing from the recommendation results. The ranking model comparisons and rankings may be based on, but not limited to, a user's query, user's features, and listing features from organic (that is, current search results) or recommendation results (that is, carousel recommended listings). I some embodiments, the ranker 910 may be the same as or similar to ranker 410 and/or ranker 710).

The ranking model may be a true pairwise comparison model designed to compare listings in pairs to determine which listing is preferred or ranks higher. The true pairwise comparison model may be trained based on bookings from organic feeds (that is, listings in current search results) while the carousel is presented vs. booking listings from the carousel.

According to embodiments, the true pairwise comparison model may generate true pairwise scoring results for each of the recommended listings in the recommendation results. The recommended listings may be displayed in a carousel in an (for example, descending) order based on the true pairwise scoring results. According to embodiments, the results of the pairwise comparisons may be aggregated to produce an overall ranking for the carousel. The overall raking score may be used to determine placement of the carousel within the current search results (for example, the overall ranking score may be compared to scores for the organic results and placed in a descending order).

In some implementations, the true pairwise comparison model may extend its scoring to score both <recommendation listing, organic listing> and <recommendation listing, recommendation listing> and use both scores to determine placement of the carousel and listing order within the carousel. The scores may be used to compare the quality of each of the listings and their relevance to the search and the user. By non-limiting example, for a given organic listing Y and highest ranking carousel recommendation listing Z, if the recommendation listing Z compared to the organic listing Y (<recommendation listing, organic listing>) results in a higher score than the recommendation listing Z (<recommendation listing, recommendation listing>), the carousel having the recommendation listing Z may be placed below the organic listing Y in the search results. Similarly, if the comparison results in a lower score, the carousel having the recommendation listing Z may be placed below the organic listing Y in the search results.

From the top to position N in the organic feed, for each organic listing, the ranking model may compare if a carousel is better based on the ranking scores. For example, the ranking model may determine the following scores for a current search: a score (query, recommendation type A listing, organic listing), a score (query, recommendation type B listing, organic listing), and a score (query, recommendation type C listing, organic listing). The highest position of all types (for example, type A, type B, type C) is the first slot to insert the recommendation carousel.

In some implementations, at least a portion of the user's stay based on the search input may be improved by booking another listing. The search expansion module 906 may be configured to generate and present a split stay recommendation, wherein the user can be booked a first portion of their stay based on the organic results and a second portion of their stay based on recommendation listings. In some implementations, options for split stays may be provided to the user similar to a listing within the organic results. In some implementations, options for split stays may be provided to the user in a carousel.

According to some embodiments, the ranking model may implement a gap rule to improve carousel placement within the organic listings. A search results page may include a maximum of N carousels, and the gap rule may be: if N>1, minimum distance between two carousels>=M listings. By non-limiting example, if a type A takes position 6 on a first page of the search results, the highest position type B can take is on a second page at position 24.

In some embodiments, the ranking model finds the top recommendation listing is more relevant than the organic search result at position i, then it ranks the carousel at position i. The search expansion module 906 may implement placement rules locking a highest-ranking organic listing at the topmost position (that is, a first listing) in the search results page to ensure the user is able to first consume results they directly searched for (that is, the organic results). By non-limiting example, a placement rule may include that the position i>=a first listing P even if the ranking score of the carousel at position i is higher than a score of first listing P. In some embodiments, the ranking model may compare different types of carousels vs. organic results, and rank different carousels based therefrom. The comparisons may be implemented per search session. Therefore, in search session i, carousel 1 may rank higher than carousel 2, but in search session j, it may be otherwise.

The ranker 910 may maximize bookings by identifying a most relevant carousel in a given search session. The most relevant carousel may then be compared to the organic results. If the most relevant carousel is determined to be more likely to be booked than organic result K, then the carousel may be inserted at position K+1 in the search results. The next relevant carousel may be inserted in a similar approach, but the next carousel has to be at least M organic listings after the previous carousels. This way the search results page is optimized through inserting multiple types of carousels.

According to embodiments, the search expansion module 906 may output carousel results 912 based on the candidate selection and ranking as described above with reference to flex model 908 and ranker 910. According to embodiments, the carousel results 912 may include an indicator that easily visually distinguishes the listing from the organic listings. The indicator may also specify what aspect of the search was relaxed/flexed to generate the carousel listings. By non-limiting example, a tooltip may be displayed on the carousel or a listing subsequent to a selected listing in the carousel to remind the user that the price was adjusted in this carousel.

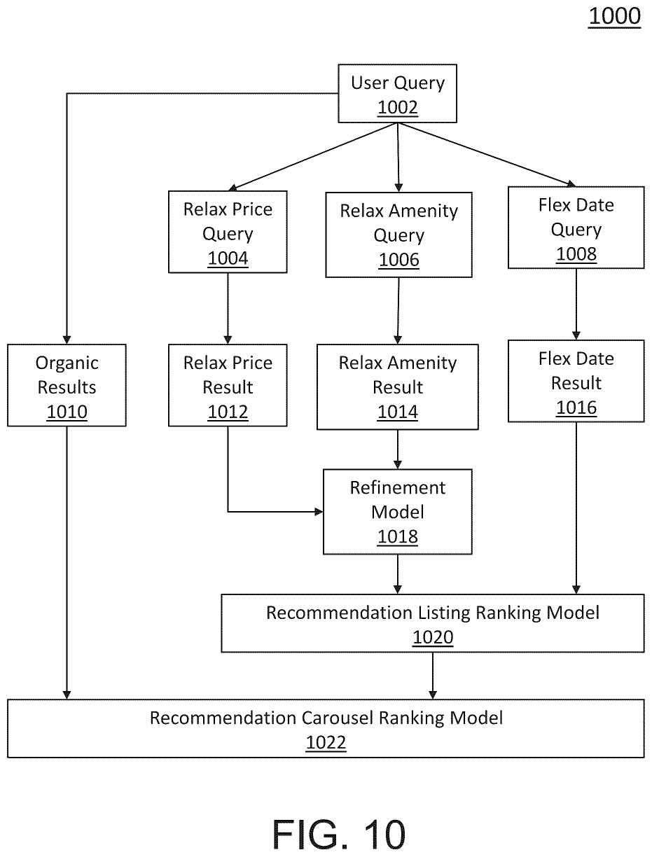

FIG. 10 illustrates a workflow 1000 of the search expansion feature, according to one or more embodiments. According to embodiments, the ranking workflow may be implemented by one or more processors. Different carousels may be generated by the one or more processors simultaneously, sequentially, or semi-simultaneously.

As shown in FIG. 10, a user query 1002 may be input and executed at a search engine (for example, search engine 232) of an online reservation platform (for example, platform 300). Organic results 1010 may be generated based on executing the user query 1002. The search expansion feature may generate one or more pivot queries based on the user query 1002. A type of the pivot queries may be determined based on what filter parameters are implemented in the user query 1002 (for example, what conditions have been set for the organic results).

Based on the user query 1002, the search expansion feature (for example, flex model 908) may flex the price, one or more amenities, and a date generating a relax price query 1004, a relax amenity query 1006, and a flex date query 1008, respectively. The relax price query 1004, relax amenity query 1006, and flex date query 1008 may be executed to generate carousels for relax price results 1010, a relax amenity results 1014, and a flex date results 1016, respectively. The search expansion feature may include a refinement model 1018 to filter and remove, for example, any duplicated filter types or other suggested results based on user preferences.

The recommendation listing ranking model 1020 may rank and order listings in the carousels (for example, as described with reference to ranker 910). The recommendation carousel ranking model 1022 may rank and determine placement for the carousels within the organic results. As described with reference to ranker 910, the placement may be determined by ranking the carousels and the organic results and comparing them to determine which listing is most relevant to the user.

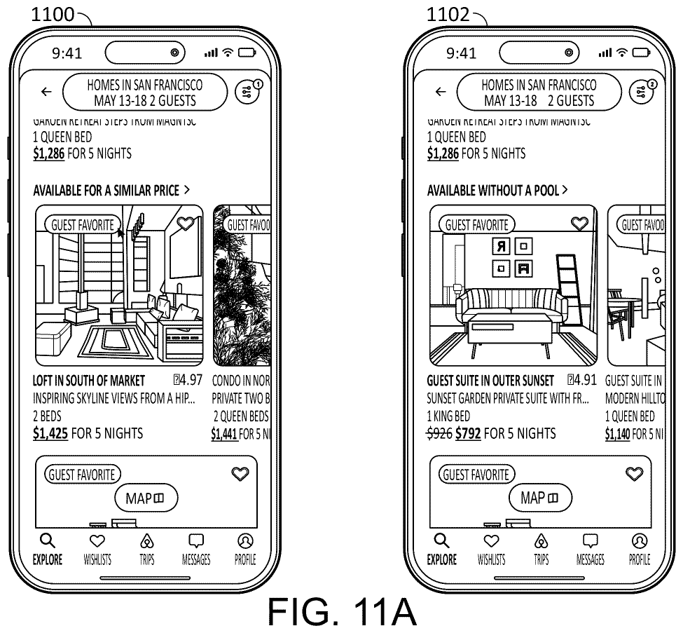

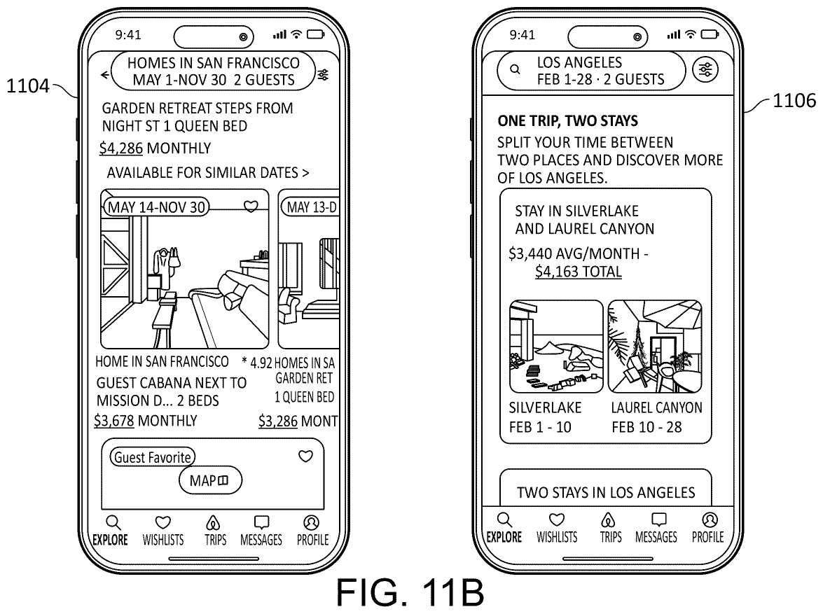

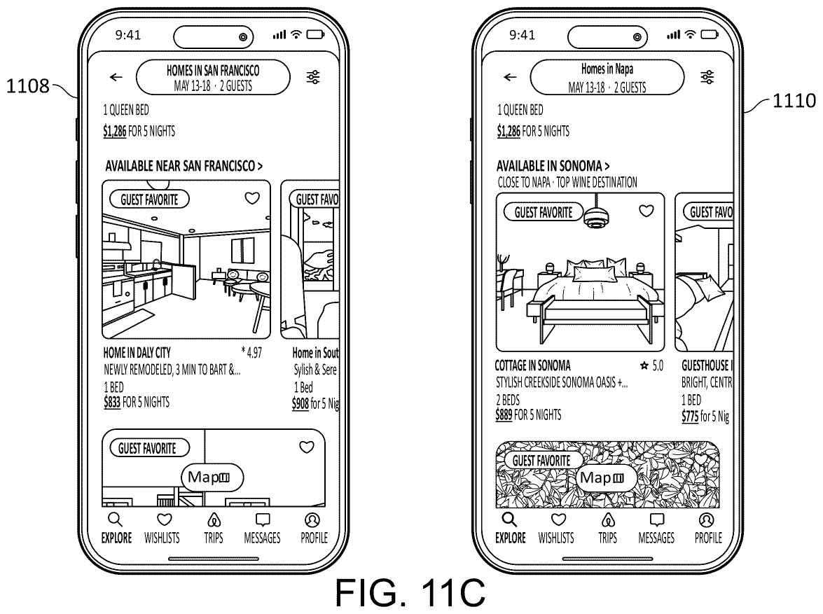

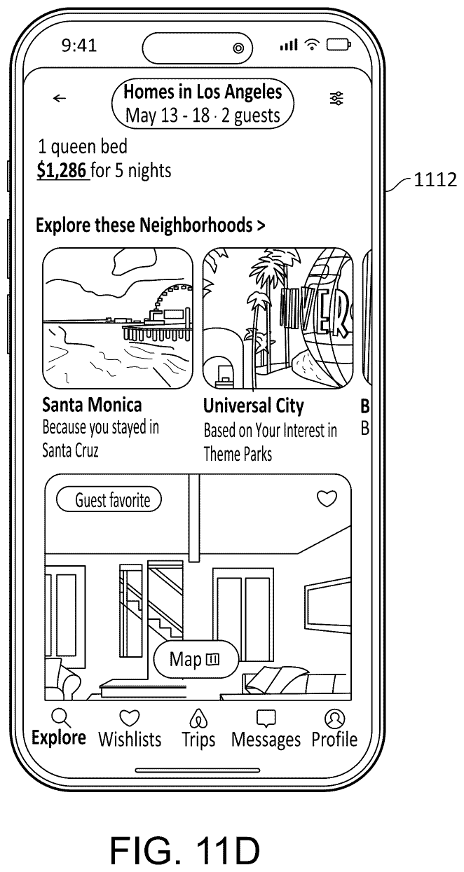

FIGS. 11A-11D illustrate an example GUI displaying carousels within a current search result generated by the search expansion feature, according to one or more embodiments. Users may interact with the carousel using horizontal motions on the GUI (in contrast to the organic results which the user may interact with using vertical motions on the GUI). As shown in FIG. 11A, display 1100 shows a price flex type carousel. Display 1102 shows a filter removal type carousel removing a pool filter from the current search result. As shown in FIG. 11B, display 1104 shows a monthly date flex type carousel. Display 1106 shows a split stay recommendation. As shown in FIG. 11C, display 1108 shows a location expansion type carousel providing recommendation results near a location of the original search (for example, San Francisco). This carousel and ranking may be based on proximity. Display 1110 shows a location similarity type carousel providing recommendation results similar to (for example, Sonoma) the original search (for example, Napa). This carousel and ranking may be based on listing features and attributes (for example, other wine destinations). As shown in FIG. 11D, display 1112 shows a location refinement type carousel providing results refined to, for example, a certain neighborhood within a city.

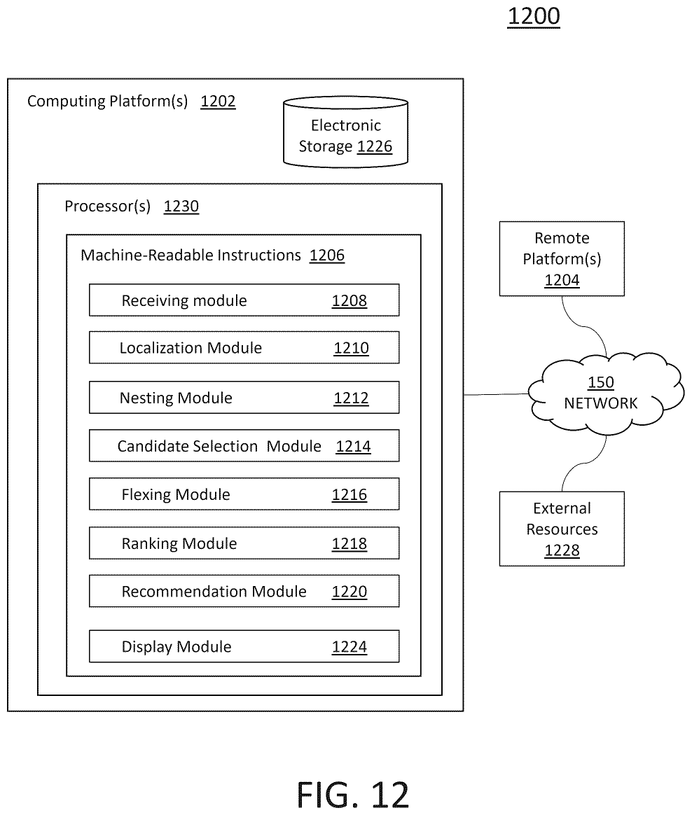

FIG. 12 is a block diagram illustrating an example system 1200 (for example, representing both client and server) with which aspects of the subject technology can be implemented. The system 1200 may be configured to improve searching on an online searchable platform, according to certain aspects of the disclosure. In some implementations, the system 1200 may include one or more computing platforms 1202. For example, the computing platform(s) 1202 may be configured to execute software algorithm(s) to encode, compress, decompress, and reconstruct video/image data.

The computing platform(s) 1202 can maintain or store data, such as in the electronic storage 1226, including correlation, contextual data, and metadata used by the computing platform(s) 1202. The computing platform(s) 1202 may be configured to communicate with one or more remote platforms according to a client/server architecture, a peer-to-peer architecture, and/or other architectures. The remote platform 1204 may be configured to communicate with other remote platforms via computing platform(s) 1202 and/or according to a client/server architecture, a peer-to-peer architecture, and/or other architectures. Users may access the system 1200 which may be hosting one or more of application(s), for example, via remote platform(s). In this way, the remote platform 1204 can be configured to cause output of the system 1200 on client device(s) of the remote platform 1204 with enabled access (for example, based on analysis by the computing platform(s) 1202 according to the stored data).

The computing platform(s) 1202 may be configured by machine-readable instructions 1206. The machine-readable instructions 1206 may be executed by the computing platform(s) to implement one or more instruction modules. The instruction modules may include computer program modules. The instruction modules being implemented may include one or more of receiving module 1208, localization module 1210, nesting module 1212, candidate selection module 1214, flexing module 1216, ranking module 1218, recommendation module 1220, display module 1224, and/or other instruction modules.

The receiving module 1208 may be configured to receive, at a client device, a query from a search input from the user. The search input may include parameters set by the user for one or more attributes of the search including, for example, dates, location, guest count, amenities, etc.

The localization module 1210 may be configured to localize locations and toponyms for locations retrieved from a dataset as search results based on the query. The localization module 1210 may localize locations/destination based on different languages, regions, and cultural contexts. The localization module 1210 enables the platform to support various language inputs in the search input. Localization may include tailoring names or descriptors of suggested destinations to match local naming conventions, addresses, and points of interest.

According to embodiments, the localization module 1210 may use LLMs for generating translations to provide toponyms in different languages (for example, Pinyin for Chinese; Hiragana and Romaji for Japanese). The localization may include, but is not limited to, translating names, points of interest, or the like, based on localized context.

The nesting module 1212 may be configured to determine nested nodes within a set of suggested destinations in a search page. Related destination suggestions may be nested as a child node from a higher-ranking and related parent node. According to some embodiments, nested nodes may be triggered based on at least one preceding destination suggestion being a country, state, city, or island of the succeeding suggestion. In this instance, the nested results may correspond to POIs, landmarks, neighborhoods, or the like.

The candidate selection module 1214 may be configured to identify qualifying recommendations for recent searches, recent PDPs, and/or destination suggestions (as described in, for example, candidate selection model 708). The candidate selection module 1214 may select a search, listing, and/or destination as a candidate based on one or any combination of user engagement, user profile, location, search history, booking history, or other signals.

The flexing module 1216 may be configured to determine one or more parameters to flex in a search based on one or any combination of the query, user profile, search results, listing inventory, or the like (as described in, for example, flex model 908). Flexing the one or more parameters results on modified queries from which pivot recommendation results may be generated. Parameters that may be flexed include guest count, date, filters, price, location, number of stays, etc. In some implementations, the flexing module 1216 is configured to only flex filters or parameters that have been selected or set in the original search (user selected). By non-limiting example, the search query may indicate that the user desires to view listings for 6 guests. The flexing module 1216 may flex the guest count+/−2 to generate a new search query for alternative listing results that may be acceptable for the user.

The ranking module 1218 may be configured to rank items including suggested destinations, searches, PDPs, and recommended listings. According to some embodiments, the ranking module 1218 may implement a ranking model to generate ranking scores based on features of query, user's features, search features, user engagement, and listing features from organic or recommendation results. In some embodiments, the ranking may be based on user origin, age, travel history, search history and recency, public information on the user and/or other users (for example, similar users based on origin, language preferences, etc.).

According to embodiments, the ranking module 1218 may score listings based on user intent, booking preferences, and relevance to organic results. Further, the ranking module 1218 may compare the score to determine an order for the listings (for example, to be displayed in descending order). The ranking module 1218 may compare scores for recommended listings and organic listings to determine where recommendations should be placed in the UI (for example, search results page).

The recommendation module 1220 may be configured to generate, by executing a search using a query, a search result including one or more listings. The recommendation module 1220 may be further configured to generate recommended listings based on modified queries by executing a new search. The recommended listings for each new search in a search session may be grouped for carousel placement. The recommendation module 1220 may generate, based on the modified query, a recommendation result including one or more recommended listings.

According to some embodiments, the system 1200 may be further configured to filter recommendation results based on a type of modification applied to a plurality of modified queries such that each filtered recommendation result corresponds to a unique type of modification within a search session. By non-limiting example, the flex module 1216 may determine two recommended results based on two different date type modifications to a query including, for example, flexing a check-in date for a first pivot search and flexing a checkout data for a second pivot search. The system 1200 may limit the display of date type modification listings to one to avoid repeating similar types of recommendations. Therefore, only one of the first or second pivot search results will be displayed to the user.

The display module 1224 may be configured to display suggested destination, searches, listings, and recommendation results based on results of one or more of the localization module 1210, nesting module 1212, candidate selection module 1214, flexing module 1216, ranking module 1218, and recommendation module 1220.

According to embodiments, the display module 1224 may present recommendation results within organic listings according to each listing's ranking score. The recommendation results may be presented on a search results page. According to some embodiments, the display module 1224 may present autocomplete search recommendations in a search page. According to some embodiments, the display module 1224 may present searches, recent PDPs, and/or destination suggestions in a search page.

In some implementations, the computing platform(s) 1202, the remote platform 1204, and/or the external resources 1228 may be operatively linked via one or more electronic communication links. For example, such electronic communication links may be established, at least in part, via the network 150 such as the Internet and/or other networks. It will be appreciated that this is not intended to be limiting, and that the scope of this disclosure includes implementations in which the computing platform(s) 1202, the remote platform 1204, and/or the external resources 1228 may be operatively linked via some other communication media.

A given remote platform may include client computing devices, such as the client device 110 or second client device, which may each include one or more processors configured to execute computer program modules (for example, the instruction modules). The computer program modules may be configured to enable an expert or user associated with the given remote platform to interface with the system 1200 and/or external resources 1228, and/or provide other functionality attributed herein to remote platform(s). By way of non-limiting example, a given remote platform and/or a given computing platform 1202 may include one or more of a server, a desktop computer, a laptop computer, a handheld computer, a tablet computing platform, a NetBook, a Smartphone, a gaming console, and/or other computing platforms. The external resources 1228 may include sources of information outside of the system 1200, external entities participating with the system 1200, and/or other resources.

Computing platform(s) 1202 may include electronic storage 1226, one or more processors 1230, and/or other components. Computing platform(s) 1202 may include communication lines, or ports to enable the exchange of information with a network and/or other computing platforms. Illustration of the computing platform(s) 1202 in FIG. 12 is not intended to be limiting. The computing platform(s) 1202 may include a plurality of hardware, software, and/or firmware components operating together to provide the functionality attributed herein to the computing platform(s) 1202. For example, the computing platform(s) 1202 may be implemented by a cloud of computing platforms operating together as the computing platform(s) 1202.

Electronic storage 1226 may comprise non-transitory storage media that electronically stores information. The electronic storage media of electronic storage 1226 may include one or both of system storage that is provided integrally (that is, substantially non-removable) with computing platform(s) 1202 and/or removable storage that is removably connectable to computing platform(s) 1202 via, for example, a port (for example, a USB port, a firewire port, etc.) or a drive (for example, a disk drive, etc.). Electronic storage 1226 may include one or more of optically readable storage media (for example, optical disks, etc.), magnetically readable storage media (for example, magnetic tape, magnetic hard drive, floppy drive, etc.), electrical charge-based storage media (for example, EEPROM, RAM, etc.), solid-state storage media (for example, flash drive, etc.), and/or other electronically readable storage media. Electronic storage 1226 may include one or more virtual storage resources (for example, cloud storage, a virtual private network, and/or other virtual storage resources). Electronic storage 1226 may store software algorithms, information determined by processor(s) 1230, information received from computing platform(s) 1202, information received from remote platform(s), and/or other information that enables computing platform(s) 1202 to function as described herein.

Processor(s) 1230 may be configured to provide information processing capabilities in computing platform(s) 1202. As such, processor(s) 1230 may include one or more of a digital processor, an analog processor, a digital circuit designed to process information, an analog circuit designed to process information, a state machine, and/or other mechanisms for electronically processing information. Although processor(s) 1230 is shown in FIG. 12 as a single entity, this is for illustrative purposes only. In some implementations, processor(s) 1230 may include a plurality of processing units. These processing units may be physically located within the same device, or processor(s) 1230 may represent processing functionality of a plurality of devices operating in coordination. Processor(s) 1230 may be configured to execute modules 1208, 1210, 1212, 1214, 1216, 1218, 1220, 1222 and/or 1224, and/or other modules. Processor(s) 1230 may be configured to execute modules 1208, 1210, 1212, 1214, 1216, 1218, 1220, 1222 and/or 1224, and/or other modules by software; hardware; firmware; some combination of software, hardware, and/or firmware; and/or other mechanisms for configuring processing capabilities on processor(s) 1230. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 1208, 1210, 1212, 1214, 1216, 1218, 1220, 1222 and/or 1224 are illustrated in FIG. 12 as being implemented within a single processing unit, in implementations in which processor(s) 1230 includes multiple processing units, one or more of modules 1208, 1210, 1212, 1214, 1216, 1218, 1220, 1222 and/or 1224 may be implemented remotely from the other modules. The description of the functionality provided by the different modules 1208, 1210, 1212, 1214, 1216, 1218, 1220, 1222 and/or 1224 described below is for illustrative purposes, and is not intended to be limiting, as any of modules 1208, 1210, 1212, 1214, 1216, 1218, 1220, 1222 and/or 1224 may provide more or less functionality than is described. For example, one or more of modules 1208, 1210, 1212, 1214, 1216, 1218, 1220, 1222 and/or 1224 may be eliminated, and some or all of its functionality may be provided by other ones of modules 1208, 1210, 1212, 1214, 1216, 1218, 1220, 1222 and/or 1224. As another example, processor(s) 1230 may be configured to execute one or more additional modules that may perform some or all of the functionality attributed below to one of modules 1208, 1210, 1212, 1214, 1216, 1218, 1220, 1222 and/or 1224.

The techniques described herein may be implemented as method(s) that are performed by physical computing device(s); as one or more non-transitory computer-readable storage media storing instructions which, when executed by computing device(s), cause performance of the method(s); or as physical computing device(s) that are specially configured with a combination of hardware and software that causes performance of the method(s).

### Hardware Overview

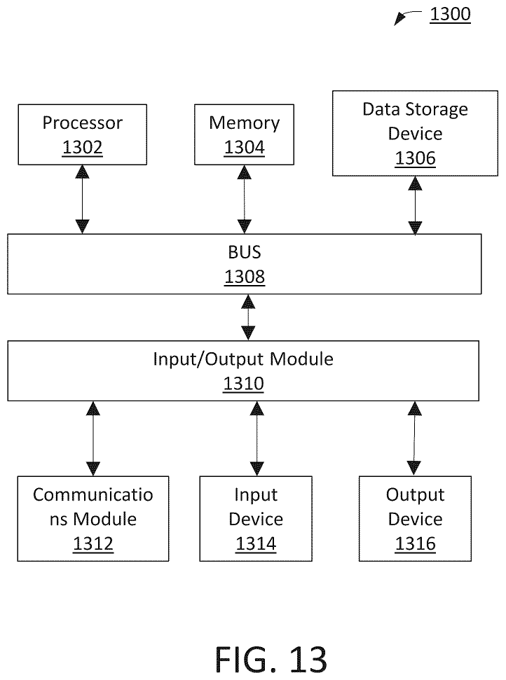

FIG. 13 is a block diagram illustrating an exemplary computer system 1300 with which the client and server of FIGS. 1-12, and method(s) described herein can be implemented. In certain aspects, the computer system 1300 may be implemented using hardware or a combination of software and hardware, either in a dedicated server, or integrated into another entity, or distributed across multiple entities. Computer system 1300 may include a desktop computer, a laptop computer, a tablet, a phablet, a smartphone, a feature phone, a server computer, or otherwise. A server computer may be located remotely in a data center or be stored locally.

Computer system 1300 includes a bus 1308 or other communication mechanism for communicating information, and a processor 1302 (for example, processors 212) coupled with bus 1308 for processing information. By way of example, the computer system 1300 may be implemented with one or more processors 1302. Processor 1302 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1300 can include, in addition to hardware, code that creates an execution environment for the computer program in question, for example, code that constitutes processor firmware, a protocol stack, a database management system, an operating system, or a combination of one or more of them stored in an included memory 1304 (for example, memories 220), such as a Random Access Memory (RAM), a Flash Memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 1308 for storing information and instructions to be executed by processor 1302. The processor 1302 and the memory 1304 can be supplemented by, or incorporated in, special purpose logic circuitry.

The instructions may be stored in the memory 1304 and implemented in one or more computer program products, for example, one or more modules of computer program instructions encoded on a computer-readable medium for execution by, or to control the operation of, the computer system 1300, and according to any method well-known to those of skill in the art, including, but not limited to, computer languages such as data-oriented languages (for example, SQL, dBase), system languages (for example, C, Objective-C, C++, Assembly), architectural languages (for example, Java, .NET), and application languages (for example, PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1304 may also be used for storing temporary variable or other intermediate information during execution of instructions to be executed by processor 1302.

A computer program as discussed herein does not necessarily correspond to a file in a file system. A program can be stored in a portion of a file that holds other programs or data (for example, one or more scripts stored in a markup language document), in a single file dedicated to the program in question, or in multiple coordinated files (for example, files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1300 further includes a data storage device 1306 such as a magnetic disk or optical disk, coupled to bus 1308 for storing information and instructions. Computer system 1300 may be coupled via input/output module 1310 to various devices. Input/output module 1310 can be any input/output module. Exemplary input/output modules 1310 include data ports such as USB ports. The input/output module 1310 is configured to connect to a communications module 1312. Exemplary communications modules 1312 (for example, communications module 218) include networking interface cards, such as Ethernet cards and modems. In certain aspects, input/output module 1310 is configured to connect to a plurality of devices, such as an input device 1314 and/or an output device 1316. Exemplary input devices 1314 include a keyboard and a pointing device, for example, a mouse or a trackball, by which a user can provide input to the computer system 1300. Other kinds of input devices 1314 can be used to provide for interaction with a user as well, such as a tactile input device, visual input device, audio input device, or brain-computer interface device. For example, feedback provided to the user can be any form of sensory feedback, for example, visual feedback, auditory feedback, or tactile feedback; and input from the user can be received in any form, including acoustic, speech, tactile, or brain wave input. Exemplary output devices 1316 include display devices, such as an LCD (liquid crystal display) monitor, for displaying information to the user.

According to one aspect of the present disclosure, the client device and server can be implemented using a computer system 1300 in response to processor 1302 executing one or more sequences of one or more instructions contained in memory 1304. Such instructions may be read into memory 1304 from another machine-readable medium, such as data storage device 1306. Execution of the sequences of instructions contained in main memory 1304 causes processor 1302 to perform the process steps described herein. One or more processors in a multi-processing arrangement may also be employed to execute the sequences of instructions contained in memory 1304. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back-end component, for example, a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of digital data communication, for example, a communication network. The communication network (for example, network 150) can include, for example, any one or more of a LAN, a WAN, the Internet, and the like. Further, the communication network can include, but is not limited to, for example, any one or more of the following tool topologies, including a bus network, a star network, a ring network, a mesh network, a star-bus network, tree or hierarchical network, or the like. The communications modules can be, for example, modems or Ethernet cards.

Computer system 1300 can include clients and servers. A client and server are generally remote from each other and typically interact through a communication network. The relationship of client and server arises by virtue of computer programs running on the respective computers and having a client-server relationship to each other. Computer system 1300 can be, for example, and without limitation, a desktop computer, laptop computer, or tablet computer. Computer system 1300 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1302 for execution. Such a medium may take many forms, including, but not limited to, non-volatile media, volatile media, and transmission media. Non-volatile media include, for example, optical or magnetic disks, such as data storage device 1306. Volatile media include dynamic memory, such as memory 1304. Transmission media include coaxial cables, copper wire, and fiber optics, including the wires forming bus 1308. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (that is, each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A computer-implemented method, performed by at least one processor, for search expansion on a platform, the method comprising:
receiving, at a client device, a query input by a user of the platform;
generating, based on executing a search using the query, a search result including one or more listings;
determining at least a modified query based on attributes of the query, the search result, and a user profile;
generating, based on the modified query, a recommendation result including one or more recommended listings; and
displaying, at the client device, the recommendation result within the search result in a search results page user interface (UI), wherein a placement of the recommendation result is based on a relevance of the recommendation result to the user profile and the search.

2. The computer-implemented method of claim 1, wherein determining the modified query further comprises flexing at least one parameter of the query.

3. The computer-implemented method of claim 1, further comprising:
determining a plurality of modified queries;
generating recommendation results for the plurality of modified queries; and
filtering the recommendation results based on a type of modification applied to the plurality of modified queries, wherein each of the filtered recommendation results correspond to a unique type of modification for a current search session on the platform.

4. The computer-implemented method of claim 1, further comprising:
generating, using a machine learning model, a first score for each of the one or more recommended listings in the recommendation result;
ranking the one or more recommended listings based on the first score; and
placing the one or more recommended listings corresponding to the modified query in a carousel for display according to the ranking, wherein the user may interact with the carousel to view the one or more recommended listings.

5. The computer-implemented method of claim 1, further comprising:
generating, using a machine learning model, a second score for each of the one or more listings in the search result;
generating, using the machine learning model, a third score for the recommendation result based on an aggregate of scores for the one or more recommended listings in the recommendation result;
comparing second scores with the third score; and
determining the placement of the recommendation result between the one or more listings based on the comparing.

6. The computer-implemented method of claim 5, wherein the placement of the recommendation result is at least M listings in the search result from a second recommendation result.

7. The computer-implemented method of claim 1, further comprising:
locking a highest-ranking listing from the one or more listings in the search result as a first listing in the search result page UI.

8. The computer-implemented method of claim 1, wherein the modified query is generated based on a modification to at least one of a check-in date, a checkout date, a total price for booking a listing, total nights, location, amenities, listing features, and removal of a filter applied by the user in the query.

9. The computer-implemented method of claim 1, wherein the modified query includes a modification to at least a filter applied by the user in the query.

10. A system for search expansion on a platform, the system comprising:
one or more processors; and
a memory storing instructions which, when executed by the one or more processors, cause the system to:
receive, at a client device, a query input by a user of the platform;
generate, based on executing a search using the query, a search result including one or more listings;
determine at least a modified query based on attributes of the query, the search result, and a user profile;
generate, based on the modified query, a recommendation result including one or more recommended listings; and
display, at the client device, the recommendation result within the search result in a search results page user interface (UI), wherein a placement of the recommendation result is based on a relevance of the recommendation result to the user profile and the search.

11. The system of claim 10, wherein the one or more processors further execute instructions to flex at least one parameter of the query.

12. The system of claim 10, wherein the one or more processors further execute instructions to:
determine a plurality of modified queries;
generate recommendation results for the plurality of modified queries; and
filter the recommendation results based on a type of modification applied to the plurality of modified queries, wherein each of the filtered recommendation results correspond to a unique type of modification for a current search session on the platform.

13. The system of claim 10, wherein the one or more processors further execute instructions to:
generate, using a machine learning model, a first score for each of the one or more recommended listings in the recommendation result;
rank the one or more recommended listings based on the first score; and
place the one or more recommended listings corresponding to the modified query in a carousel for display according to a ranking, wherein the user may interact with the carousel to view the one or more recommended listings.

14. The system of claim 10, wherein the one or more processors further execute instructions to:
generate a second score for each of the one or more listings in the search result;
generate a third score for the recommendation result based on an aggregate of scores for the one or more recommended listings in the recommendation result;
compare second scores with the third score; and
determine the placement of the recommendation result between the one or more listings based on the comparing.

15. The system of claim 14, wherein the placement of the recommendation result is at least M listings in the search result from a second recommendation result.

16. The system of claim 10, wherein the one or more processors further execute instructions to:
lock a highest-ranking listing from the one or more listings in the search result as a first listing in the search result page UI.

17. The system of claim 10, wherein the modified query is generated based on a modification to at least one of a check-in date, a checkout date, a total price for booking the listing, total nights, location, amenities, listing features, and removal of a filter applied by the user in the query.

18. A non-transitory computer-readable medium storing a program for implementing search expansion on a platform, which when executed by a computer, configures the computer to:
receive, at a client device, a query input by a user of the platform;
generate, based on executing a search using the query, a search result including one or more listings;
determine at least a modified query based on attributes of the query, the search result, and a user profile;
generate, based on the modified query, a recommendation result including one or more recommended listings; and
display, at the client device, the recommendation result within the search result in a search results page user interface (UI), wherein a placement of the recommendation result is based on a relevance of the recommendation result to the user profile and the search.

19. The non-transitory computer-readable medium of claim 18, further configures the computer to:
determine a plurality of modified queries;
generate recommendation results for the plurality of modified queries; and
filter the recommendation results based on a type of modification applied to the plurality of modified queries, wherein each of the filtered recommendation results correspond to a unique type of modification for a current search session on the platform.

20. The non-transitory computer-readable medium of claim 18, further configures the computer to:
generate, using a machine learning model, a first score for each of the one or more recommended listings in the recommendation result;
rank the one or more recommended listings based on the first score; and
place the one or more recommended listings corresponding to the modified query in a carousel for display according to a ranking, wherein the user may interact with the carousel to view the one or more recommended listings.
